(19) United States
(12) Patent Application Publication
(10) Pub. No.: US 2026/0243553 A1
(43) Pub. Date: Aug. 20, 2026

(54) APPARATUS AND METHOD FOR MAINTAINING A MINIMUM APPROACH DISTANCE FOR ENERGIZED UTILITY ASSETS

(71) Applicant: Utility Solutions, Inc., Hickory, NC (US)

(72) Inventors: Leah Barnes, Taylorsville, NC (US); Thomas Beane, Hudson, NC (US); Benjamin Dean Houston, Hickory, NC (US); Jonathon S. Spencer, Catawba, NC (US)

(21) Appl. No.: 19/056,932

(22) Filed: Feb. 19, 2025

(51) Int. Cl. G01B 3/08

(52) U.S. Cl. CPC G01B 3/08

(57) ABSTRACT

An apparatus is disclosed. The apparatus including a base adapted to be held by a utility worker; an end spaced from and extending outwardly from the base; indicia disposed on the apparatus, the indicia running a length of the apparatus such that the indicia runs from an end point of the end to a base point of the base; and wherein the indicia indicates a measurement from the utility worker to an energized utility asset, the measurement being at a minimum measurement value at the end point and at its maximum measurement value at the base point.

### BACKGROUND OF THE INVENTION

This application relates to an apparatus and method for maintaining a minimum approach distance and, more particularly, to an electrically insulated pole having indicia thereon that allows a utility worker to verify compliance with the minimum approach distance.

Electrically insulated poles, also known as a hotstick, are well-known in the utility industry. Hotsticks are commonly used to activate or deactivate utility assets, such as circuit breakers and the like. One of the issues utility workers face is how far from an energized utility asset a worker must be from the energized utility asset. This is commonly referred to as minimum approach distance (MAD) which is a guideline published by the Occupational Safety and Health Administration (OSHA) regarding how close an employee can be to exposed energized parts. These guidelines are adopted by utilities for the safety of their workers and is dependent on the voltage of the energized utility asset and a few other factors.

One of the real-world issues utility workers face is how to determine the distance a worker is to an energized utility asset. It isn't enough to simply know what the MAD is, the worker has to be able to actually comply with the MAD. For example, a utility worker cannot simply eyeball the distance or use a tape measure which is conductive and incapable of extending out long distances.

Accordingly, there is a need for an apparatus and method that allows a utility worker to safely determine and verify the MAD in the field.

### BRIEF SUMMARY OF THE INVENTION

This problem is addressed by an electrically insulated pole having indicia thereon to allow a utility worker to determine and verify a distance between the utility worker and the energized utility asset.

According to an aspect of the invention, an apparatus includes a base adapted to be held by a utility worker; an end spaced from and extending outwardly from the base; indicia disposed on the apparatus, the indicia running a length of the apparatus such that the indicia runs from an end point of the end to a base point of the base; and wherein the indicia indicates a measurement from the utility worker to an energized utility asset, the measurement being at a minimum measurement value at the end point and at its maximum measurement value at the base point.

According to another aspect of the invention, an apparatus includes a base section adapted to be held by a utility worker; an intermediate section configured to be nested within the base section in a collapsed position and extended outwardly from the base section in an extended position; an end section configured to be nested within the intermediate section in a collapsed position and extended outwardly from the intermediate section in an extended position; indicia disposed on the base section, intermediate section, and end section, the indicia running a length of the apparatus, such that the indicia runs from an end point of the end section to a base point of the base section; and wherein the indicia indicates a measurement from the utility worker to an energized utility asset, the measurement being zero at the end point and at its maximum measurement at the base point.

According to another aspect of the invention, a method of maintaining a minimum approach distance includes the steps of determining a minimum approach distance for an energized utility asset; choosing an electrically insulated apparatus having a length equal to or greater than the minimum approach distance; extending the apparatus from a utility worker to the energized utility asset and using indicia disposed on the apparatus to measure a distance between a utility worker and the energized utility asset; and recording the measurement between the utility worker and the energized asset to verify the utility worker is maintaining a minimum approach distance from the energized utility asset.

### BRIEF DESCRIPTION OF THE DRAWINGS

The invention may be best understood by reference to the following description taken in conjunction with the accompanying drawing figures, in which:

FIG. 1 shows an exemplary electrically insulated extendable pole being used to measure a horizontal distance to a utility asset;

FIG. 2 shows the electrically insulated extendable pole of FIG. 1, in a collapsed configuration;

FIG. 3 illustrates the electrically insulated extendable pole of FIG. 1;

FIG. 4 shows a user using the electrically insulated extendable pole of FIG. 1; and

FIG. 5 shows an exemplary electrically insulated pole being used to measure a horizontal distance to a utility asset.

### DETAILED DESCRIPTION OF THE INVENTION

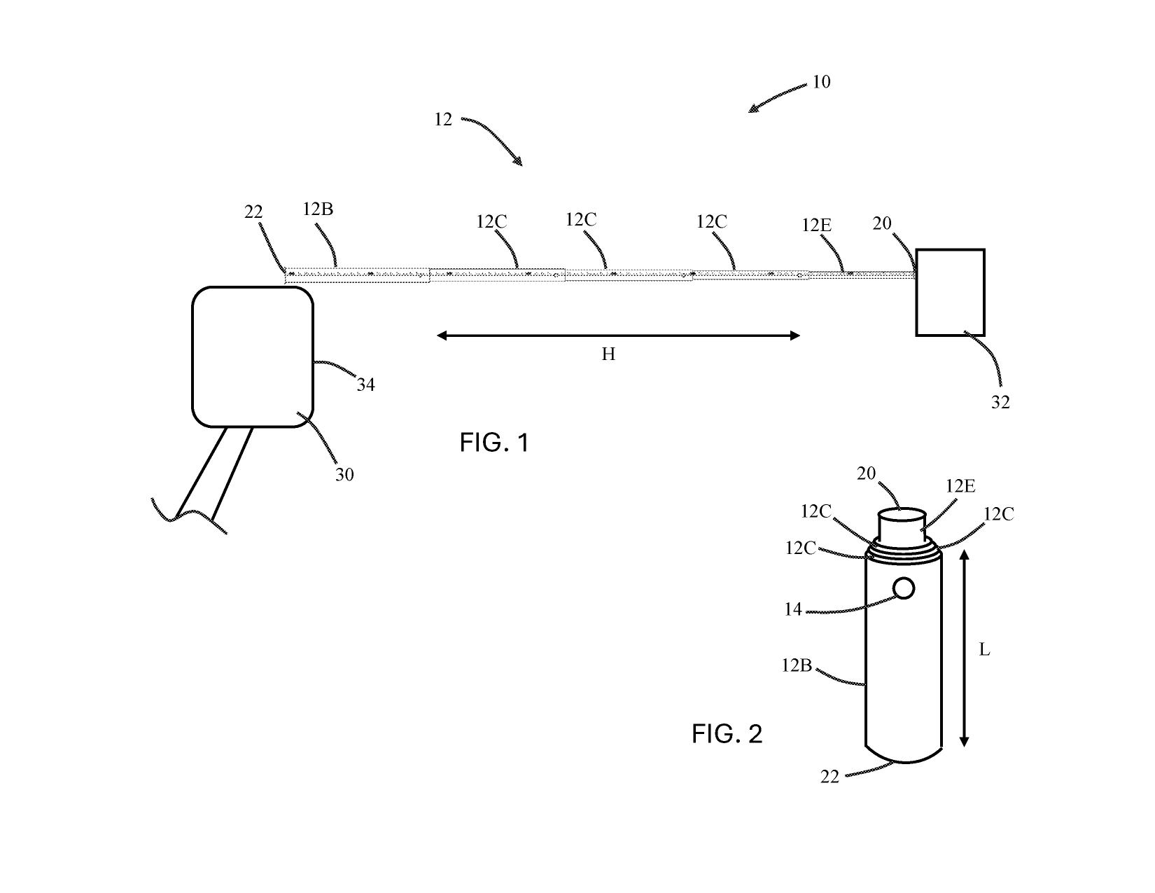

Referring to the drawings wherein identical reference numerals denote the same elements throughout the various views, FIGS. 1-4 illustrate an exemplary apparatus in the form of an electrically insulated extendable pole 10 (hereinafter referred to as a "hotstick"). The hotstick 10 includes a plurality of pole sections 12 made of an electrically insulating material such as fiberglass. Any suitable insulating material may be used. Each of the sections 12 have a diameter different from an adjacent section. In other words, the sections 12 are sized to allow the sections 12 to be collapsed into an adjacent section 12, FIG. 2, such that when the hotstick 10 is collapsed, the hotstick 10 has a length of about equal to a length "L" of a single section 12.

For clarity, a base or base section 12B has a first diameter, adjacent section 12C has a second diameter, the first diameter being larger than the second diameter to allow section 12C to nest inside of section 12B. Each adjacent section 12C extending from the base section 12B has a smaller diameter than a diameter of a previous section 12C, such that an end or end section 12E has the smallest diameter of all of the sections 12. It should be appreciated that the adjacent section 12C is an intermediate section between the base section 12B and end section 12E. It should also be appreciated that in its smallest form, the hotstick 10 may not include an intermediate section 12C. As used herein, base section and end section refer to portions of the hotstick 10 closest to the base point 22 and end point 20.

Each of the sections 12 are locked together when extended using an aperture 14 and actuator 16 that extends through the aperture 14. For example, base section 12Bincludes an aperture 14 and when the adjacent section 12C is extended outwardly from the base section 12B, an actuator 16 of the section 12C engages the aperture 14 of the base section to lock the base section 12B and adjacent section 12C in the extended position. Further, the adjacent section 12Cincludes an aperture 14 on an opposing end of the adjacent section 12C to engage an actuator 16 of another adjacent section 12C or the end section 12E. It should be appreciated that the apertures and actuators may be reversed, i.e. the base section may include the actuator 16 for engaging an aperture 14 of adjacent section 12C.

As shown in FIG. 1, the hotstick 10 includes five sections 12 that when fully extended, extend a pre-determined length – the five sections shown extend approximately 8ft (2.44 meters). It should be appreciated that other numbers of sections may be used depending on the use of the hotstick and the desired length (for example, the length of hotstick 10 in FIG. 2 is approximately 11ft-6in or 3.5 meters). Each of the sections 12 include indicia 18 thereon. The indicia 18 is in the form of a ruler and has markings to indicate inches and feet. Other dimensions such as centimeters and meters may also be marked on the sections 12. The indicia 18 starts on the end section 12Esuch that end point 20 is equal to zero.

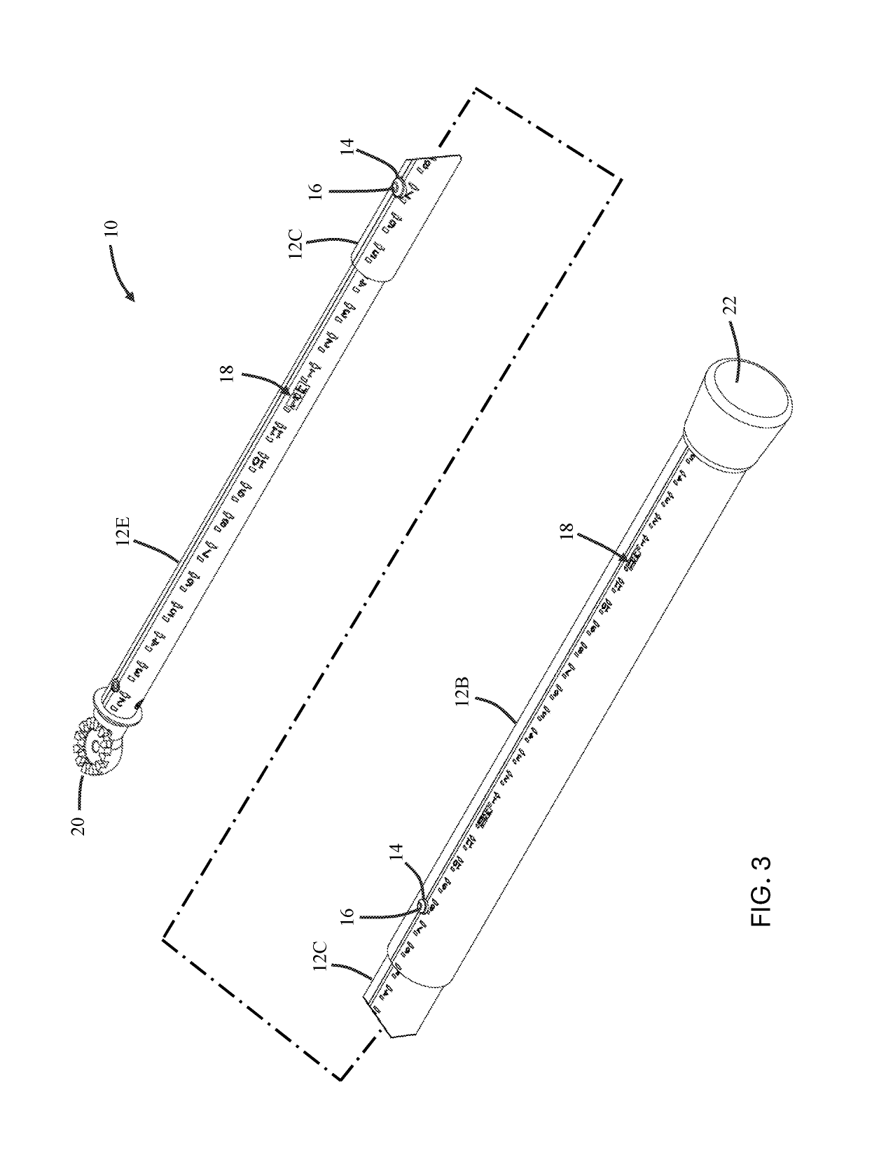

As illustrated in FIG. 3, the indicia 18 goes up in value (1 inch, 2 inch, 3 inch, etc.) as the indicia goes from end point 20 towards the base section 12B; thus, the smallest measurement value would be at end 20 and the largest measurement value would be at a base point 22 (ex. 11ft). As shown, the end section 12E is marked in inches and shows a foot marking when twelve inches is reached. Each section continues the indicia 18 until the indicia reaches the base point 22 of the base section 12B. Thus, the indicia runs the entire length of the hotstick 10 from end point 20 to base point 22.

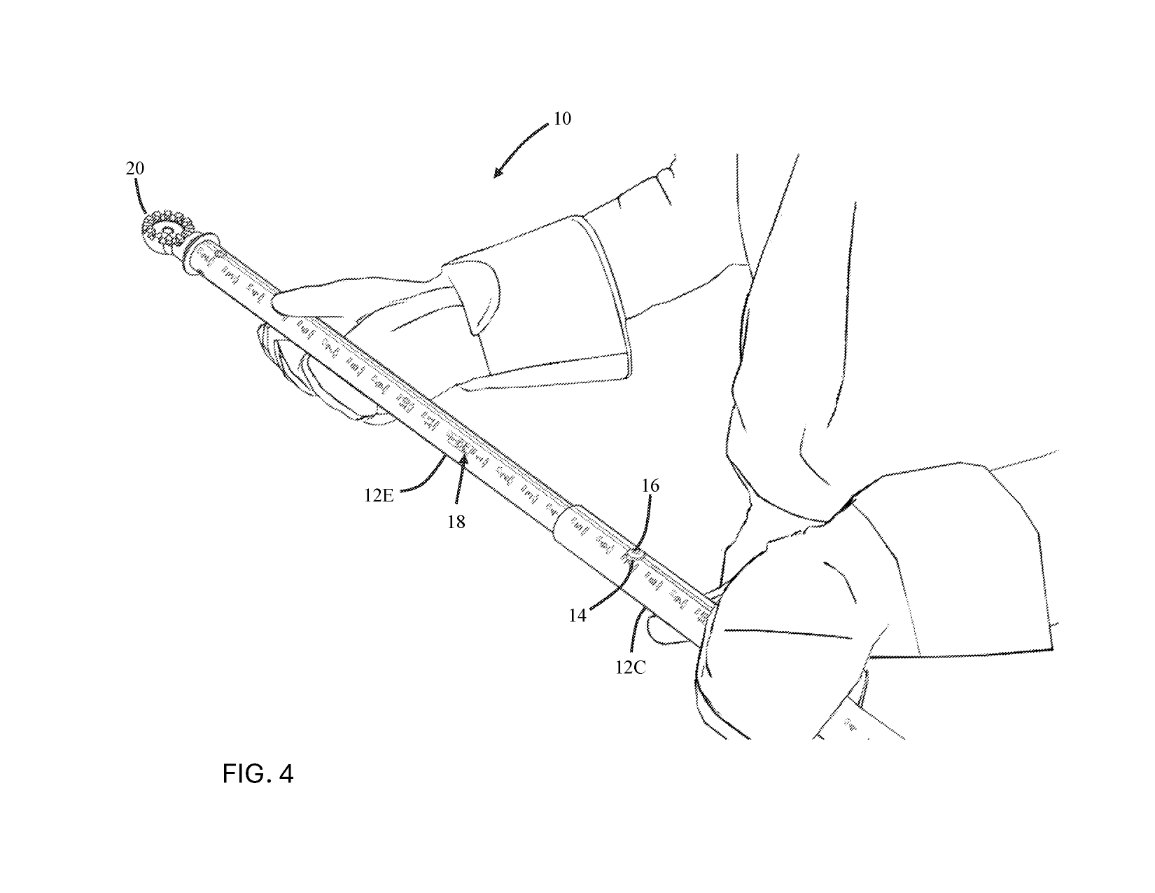

The indicia 18 on the hotstick is designed such that when an adjacent section is extended, the numbering continues uninterrupted. For example, in FIG. 4, it is clearly shown that when the indicia 18 reaches the end of the end section 12E, the indicia continues uninterrupted onto the next adjacent section 12C. This allows a utility worker to get an accurate measurement between the utility worker and an energized utility asset to verify that a minimum approach distance (MAD) has been maintained.

As shown in FIG. 1, the hotstick 10 is fully extended horizontally "H" between a bucket 30 of a bucket truck and an energized utility asset 32. A utility worker can read the indicia where the hotstick 10 crosses a front side 34 of the bucket 30 to determine the horizontal distance between the bucket and the energized utility asset, thereby verifying that MAD has been maintained.

In use, a utility worker can use the hotstick 10 in one of two ways. For example, if the utility worker knows the MAD required or has determined the MAD required, the utility worker can extend the hotstick 10 out a predetermined distance using the indicia 18 on the hotstick and then use the hotstick to maintain MAD as the utility worker moves around. It should be appreciated that the terms "extend" or "extended" may refer to holding the hotstick 10 out between the utility worker and the energized utility asset or the actual extension of the hotstick 10 by moving sections from the collapsed position to the extended position to extend the length of the hotstick 10. In a second example, the utility worker may already be in position, such as in a bucket 30 of the bucket truck and needs to verify MAD. In this case, the utility worker extends the hotstick 10 out until the end point 20 reaches the energized utility asset 32. Once the energized utility asset 32 has been reached, the utility worker can record the measurement provided by the indicia 18 to verify MAD has been maintained. It should be appreciated, that the step of recording may be a mental notation of the measured distance, a written recordation of the measured distance, or any other suitable type of recordation to compare against the MAD. If the MAD has not been maintained or is not in compliance, the utility worker can move to a new location. Once in the new location, the utility worker records a new measurement to the energized utility asset and determines if the new location is in compliance with MAD.

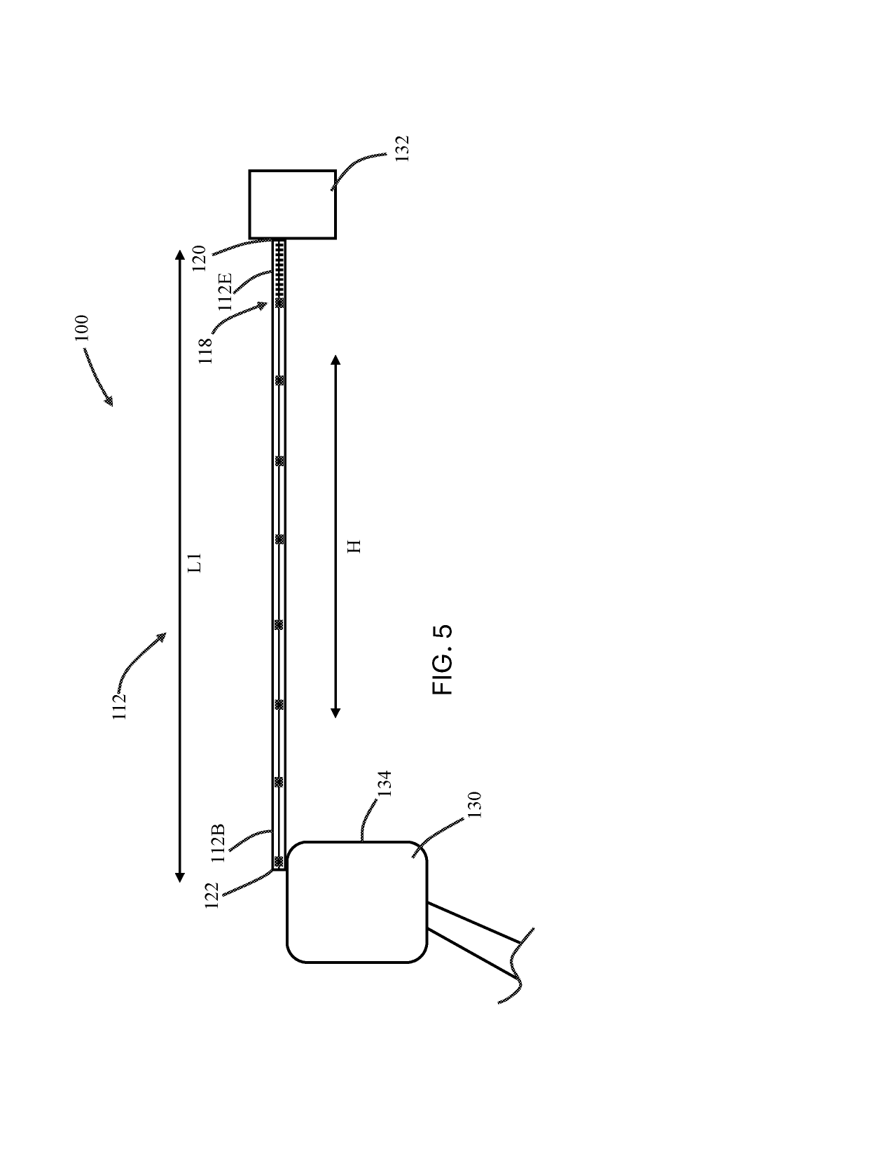

Referring to FIG. 5 an exemplary apparatus in the form of an electrically insulated pole 100 (hereinafter referred to as a "hotstick") is shown. Like hotstick 10, hotstick 100 is formed of an electrically insulated material such as fiberglass and extends a predetermined distance. Hotstick 100 includes a single pole section 112 instead of a plurality of pole sections that collapse into a smaller form factor like hotstick 10. Hotstick 100 extends from a base point 122 of a base or base section 112B, where a user holds the hotstick 100, to an end point 120 of an end or end section 112E and includes indicia 118 along its entire length "L1". As used herein, base section and end section refer to portions of the hotstick closest to the base point 122 and end point 120. The end 112Ebeing spaced from the base 112B. The indicia 118 is in the form of a ruler and has markings to indicate inches and feet. Other dimensions such as centimeters and meters may also be used. The indicia 118 starts at end point 120 such that end point 120 is equal to zero or a predetermined minimum measurement value to compensate for an attachment attached at the end 112E at end point 120. The indicia 118 goes up in value (1 inch, 2 inch, 3 inch, etc.) as the indicia goes from end point 120 towards the base point 122; thus, the smallest measurement value would be at end 120 and the largest measurement value would be at a base point 122 (ex. 11ft).

The hotstick 100 may be formed in varying lengths, such as 1ft, 2ft, 3ft, 4ft…11ft…. Like hotstick 10, in use, a utility worker can use the hotstick 100 in one of two ways. For example, if the utility worker knows the MAD required or has determined the MAD required, the utility worker can choose a hotstick 100 having a length L1 equal to or slightly longer than the MAD and then use the hotstick 100 to maintain MAD as the utility worker moves around. In a second example, the utility worker may already be in position, such as in a bucket of the bucket truck and needs to verify MAD. In this case, the utility worker chooses a hotstick 100 having a length L1 longer than MAD and holds the hotstick 100 out until the end point 120 reaches the energized utility asset 132 (i.e. extends the hotstick out between the utility worker and energized utility asset). Once the energized utility asset 132 has been reached, the utility worker can record the measurement provided by the indicia 118 to verify MAD has been maintained. If the MAD has not been maintained or is not in compliance, the utility worker can move to a new location. Once in the new location, the utility worker records a new measurement to the energized utility asset and determines if the new location is in compliance with MAD.

The foregoing has described an apparatus and method for maintaining a minimum approach distance. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends any novel one, or any novel combination, of the features disclosed in this specification (including any accompanying claims, abstract and drawings), or to any novel one, or any novel combination, of the steps of any method or process so disclosed.

What is claimed is:

1. An apparatus, comprising:
a base adapted to be held by a utility worker;
an end spaced from and extending outwardly from the base;
indicia disposed on the apparatus, the indicia running a length of the apparatus such that the indicia runs from an end point of the end to a base point of the base; and
wherein the indicia indicates a measurement from the utility worker to an energized utility asset, the measurement being at a minimum measurement value at the end point and at its maximum measurement value at the base point.

2. The apparatus of claim 1, wherein the end is configured to be nested within the base in a collapsed position and extended outwardly from the base in an extended position.

3. The apparatus of claim 2, wherein the measurement is continuous from the end point to the base point when the apparatus is in the extended position.

4. The apparatus of claim 1, wherein the apparatus is made of an electrically insulated material.

5. The apparatus of claim 2, wherein the end includes an actuator and the base includes an aperture for receiving the actuator therein to lock the end and base in the extended position.

6. The apparatus of claim 5, wherein depressing the actuator allows the end to be collapsed into the base.

7. The apparatus of claim 1, further including at least one intermediate section between the base and the end.

8. An apparatus, comprising:
a base section adapted to be held by a utility worker;
an intermediate section configured to be nested within the base section in a collapsed position and extended outwardly from the base section in an extended position;
an end section configured to be nested within the intermediate section in a collapsed position and extended outwardly from the intermediate section in an extended position;
indicia disposed on the base section, intermediate section, and end section, the indicia running a length of the apparatus, such that the indicia runs from an end point of the end section to a base point of the base section; and
wherein the indicia indicates a measurement from the utility worker to an energized utility asset, the measurement being zero at the end point and at its maximum measurement at the base point.

9. The apparatus of claim 8, wherein the measurement is continuous from the end point to the base point when the apparatus is in the extended position.

10. The apparatus of claim 8, wherein the base section, intermediate section, and end section are made of an electrically insulated material.

11. The apparatus of claim 8, wherein the end section includes an actuator and the intermediate section includes an aperture disposed on a first end for receiving the actuator therein to lock the end section and intermediate section in the extended position.

12. The apparatus of claim 11, wherein the intermediate section further includes an actuator disposed on an opposing second end of the intermediate section.

13. A method of maintaining a minimum approach distance, comprising:
determining a minimum approach distance for an energized utility asset;
choosing an electrically insulated apparatus having a length equal to or greater than the minimum approach distance;
extending the apparatus from a utility worker to the energized utility asset and using indicia disposed on the apparatus to measure a distance between a utility worker and the energized utility asset; and
recording the measurement between the utility worker and the energized asset to verify the utility worker is maintaining a minimum approach distance from the energized utility asset.

14. The method of claim 13, wherein the apparatus includes a single pole section having a fixed length.

15. The method of claim 13, wherein the apparatus includes a plurality of pole sections configured to be nested within a base section in a collapsed position and extended outwardly from the base section in an extended position.

16. The method of claim 15, wherein the apparatus has a variable length.

17. The method of claim 13, wherein the apparatus is extended horizontally.

18. The method of claim 13, further including the step of the utility worker moving to a new location away from the energized utility asset if the minimum approach distance is not maintained.

19. The method of claim 18, further including the step of using the apparatus to record a new measurement at the new location to verify the utility worker is in compliance with the minimum approach distance.

20. The method of claim 15, further including the step of extending the plurality of sections from the collapsed position to a predetermined extended position.
